(19) United States
(12) Patent Application Publication
(10) Pub. No.: US 2026/0107193 A1
(43) Pub. Date: Apr. 16, 2026

(54) INTER UPLINK MULTIPLE TRANSMISSION-RECEPTION POINTS (TRPS) MOBILITY

(71) Applicant: QUALCOMM Incorporated, San Diego, CA (US)

(72) Inventors: Qing LI, Princeton Junction, NJ (US); Junyi LI, Greentown, PA (US)

(21) Appl. No.: 19/337,615

(22) Filed: Sep. 23, 2025

Related U.S. Application Data
(60) Provisional application No. 63/706,013, filed on Oct. 10, 2024.

(51) Int. Cl. H04W 36/00; H04L 5/00; H04W 72/21; H04W 72/232; H04W 74/0833

(52) U.S. Cl. CPC H04W 36/0069; H04L 5/005; H04W 72/21; H04W 72/232; H04W 74/0833

(57) ABSTRACT

Methods, systems, and devices for wireless communications are described. A UE may receive, from a network entity, a control signal indicating a set of multiple uplink transmission-reception points (TRPs) associated with the network entity and a sounding reference signal (SRS) configuration for an uplink handover procedure associated with the plurality of uplink TRPs. The SRS configuration may indicate one or more SRS resource sets for an SRS beam sweeping procedure. The UE may transmit one or more SRSs via one or more SRS resources associated with the one or more SRS resource sets in accordance with the SRS beam sweeping procedure. The UE may receive, based on the one or more SRSs, an indication to perform the uplink handover procedure from a first uplink TRP of the set of multiple of uplink TRPs to a second uplink TRP of the set of multiple of uplink TRPs.

### CROSS REFERENCES

The present Application for Patent claims benefit of U.S. Provisional Patent Application No. 63/706,013 by LI et al., entitled “INTER UPLINK MULTIPLE TRANSMISSION-RECEPTION POINTS (TRPS) MOBILITY,” filed Oct. 10, 2024, assigned to the assignee hereof, and expressly incorporated herein.

### FIELD OF TECHNOLOGY

The present disclosure relates to wireless communications, including inter uplink multiple transmission-reception points (TRPs) mobility.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a network entity, a control signal indicating a set of multiple uplink transmission-reception points (TRPs) associated with the network entity and a sounding reference signal (SRS) configuration for an uplink handover procedure associated with the set of multiple uplink TRPs, the SRS configuration indicating one or more SRS resource sets for an SRS beam sweeping procedure, transmitting one or more SRSs via one or more SRS resources associated with the one or more SRS resource sets in accordance with the SRS beam sweeping procedure, and receiving, based on the one or more SRSs, an indication to perform the uplink handover procedure from a first uplink TRP of the set of multiple uplink TRPs to a second uplink TRP of the set of multiple uplink TRPs.

A UE for wireless communications is described. The UE may include one or more memories storing processor executable code, and one or more processors coupled with the one or more memories. The one or more processors may individually or collectively be operable to execute the code to cause the UE to receive, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure, transmit one or more SRSs via one or more SRS resources associated with the one or more SRS resource sets in accordance with the SRS beam sweeping procedure, and receive, based on the one or more SRSs, an indication to perform the uplink handover procedure from a first uplink TRP of the set of multiple uplink TRPs to a second uplink TRP of the set of multiple uplink TRPs.

Another UE for wireless communications is described. The UE may include means for receiving, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure, means for transmitting one or more SRSs via one or more SRS resources associated with the one or more SRS resource sets in accordance with the SRS beam sweeping procedure, and means for receiving, based on the one or more SRSs, an indication to perform the uplink handover procedure from a first uplink TRP of the set of multiple uplink TRPs to a second uplink TRP of the set of multiple uplink TRPs.

A non-transitory computer-readable medium storing code for wireless communications is described. The code may include instructions executable by one or more processors to receive, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure, transmit one or more SRSs via one or more SRS resources associated with the one or more SRS resource sets in accordance with the SRS beam sweeping procedure, and receive, based on the one or more SRSs, an indication to perform the uplink handover procedure from a first uplink TRP of the set of multiple uplink TRPs to a second uplink TRP of the set of multiple uplink TRPs.

Some examples of the method, UEs, and non-transitory computer-readable medium described herein may further include operations, features, means, or instructions for transmitting, to the first uplink TRP, a scheduled uplink transmission and receiving, from the network entity based on the scheduled uplink transmission, a second control signal indicating to perform SRS beam sweeping in accordance with the one or more SRS resource sets for the SRS beam sweeping procedure.

Some examples of the method, UEs, and non-transitory computer-readable medium described herein may further include operations, features, means, or instructions for receiving a medium access control (MAC) control element (MAC-CE) indicating an activation of an SRS resource set associated with the one or more SRS resource sets for the SRS beam sweeping procedure.

Some examples of the method, UEs, and non-transitory computer-readable medium described herein may further include operations, features, means, or instructions for receiving a downlink control indication (DCI) including at least an identifier (ID) of an SRS resource set associated with the one or more SRS resource sets or a quantity of repetitions associated with the SRS beam sweeping procedure.

Some examples of the method, UEs, and non-transitory computer-readable medium described herein may further include operations, features, means, or instructions for transmitting, to the first uplink TRP, an uplink transmission, where a response timer may be initiated based on the uplink transmission.

Some examples of the method, UEs, and non-transitory computer-readable medium described herein may further include operations, features, means, or instructions for performing the SRS beam sweeping procedure via the one or more SRS resource sets based on a failure to receive a response to the uplink transmission and an expiration of the response timer.

Some examples of the method, UEs, and non-transitory computer-readable medium described herein may further include operations, features, means, or instructions for transmitting, to the second uplink TRP, a random access message including a dedicated preamble sequence or a contention based preamble sequence based on the indication to perform the uplink handover procedure, the random access message indicating the uplink handover procedure.

Some examples of the method, UEs, and non-transitory computer-readable medium described herein may further include operations, features, means, or instructions for receiving, from the network entity, a random access response indicating a timing advance (TA) value associated with the second uplink TRP and transmitting, to the second uplink TRP, a second random access message indicating confirmation of the uplink handover procedure and in accordance with the TA value.

Some examples of the method, UEs, and non-transitory computer-readable medium described herein may further include operations, features, means, or instructions for receiving the indication to perform the uplink handover procedure, where the indication includes a physical downlink control channel (PDCCH) order physical random access channel (PRACH) message or a radio resource control (RRC) reconfiguration message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports inter uplink multiple transmission-reception points (TRPs) mobility in accordance with one or more aspects of the present disclosure.

FIG. 2 shows an example of a network architecture that supports inter uplink multiple TRPs mobility in accordance with one or more aspects of the present disclosure.

FIG. 3 shows an example of a wireless communications system that supports inter uplink multiple TRPs mobility in accordance with one or more aspects of the present disclosure.

FIG. 4 shows an example of a process flow that supports inter uplink multiple TRPs mobility in accordance with one or more aspects of the present disclosure.

FIG. 5 shows an example of a process flow that supports inter uplink multiple TRPs mobility in accordance with one or more aspects of the present disclosure.

FIGS. 6 and 7 show block diagrams of devices that support inter uplink multiple TRPs mobility in accordance with one or more aspects of the present disclosure.

FIG. 8 shows a block diagram of a communications manager that supports inter uplink multiple TRPs mobility in accordance with one or more aspects of the present disclosure.

FIG. 9 shows a diagram of a system including a device that supports inter uplink multiple TRPs mobility in accordance with one or more aspects of the present disclosure.

FIGS. 10 through 12 show flowcharts illustrating methods that support inter uplink multiple TRPs mobility in accordance with one or more aspects of the present disclosure.

### DETAILED DESCRIPTION

In some wireless communications systems, a network entity may communicate with one or more uplink transmission-reception points (TRPs). The one or more uplink TRPs may improve communications reliability associated with uplink communication between a user equipment (UE) and the network entity. For example, the UE may transmit an uplink transmission to a first uplink TRP (e.g., which may be closer to the UE than the network entity). The first uplink TRP may receive the uplink transmission, and the first uplink TRP may forward the uplink signal to the network entity. The network entity may transmit a downlink signal to the UE. In some cases, changing channel conditions (e.g., based on UE mobility) may degrade a connection quality between the UE and the first uplink TRP. It may be beneficial for the network entity and the UE to conduct a handover procedure from the first uplink TRP to the second uplink TRP.

According to techniques described herein, the network entity or the UE may indicate or initiate a sounding reference signal (SRS) sweeping procedure based on an uplink connection quantity between the UE and a first uplink TRP. The network entity may transmit a control signal indicating an SRS configuration to the UE. The UE may transmit an uplink transmission to the network entity. In some examples, the network entity may determine to transmit an indication for the UE to perform the SRS sweeping procedure based on a measurement of the uplink transmission satisfying a threshold. In some examples, the UE may determine to initiate the SRS sweeping procedure based on a failure to receive a response to the uplink transmission within a response window (e.g., based on a response timer). The UE may transmit one or more SRSs as part of an SRS sweeping procedure to enable the network entity (e.g., the one or more TRP in communication with the network entity) to measure an uplink connection quality between the UE and the one or more TRPs. For example, network entity (e.g., the one or more TRPs in communication with the network entity) may perform uplink measurements on the one or more SRSs to determine the uplink connection quality. The network entity may initiate an uplink TRP handover procedure based on one or more measurements of the one or more SRSs at the first uplink TRP or at a second uplink TRP satisfying a threshold. The network entity may transmit an indication to perform an uplink TRP handover procedure from the first uplink TRP to the second uplink TRP associated with a higher connection quality based on the one or more measurements. The UE may perform a random access channel (RACH) procedure with the second uplink TRP, and the UE may transmit one or more subsequent uplink signals to the second uplink TRP.

Aspects of the disclosure are initially described in the context of wireless communications systems. Additional aspects of the disclosure may be described in the context of a network architecture or process flows. Aspects of the disclosure are further illustrated by and described with reference to apparatus diagrams, system diagrams, and flowcharts that relate to inter uplink multiple TRPs mobility.

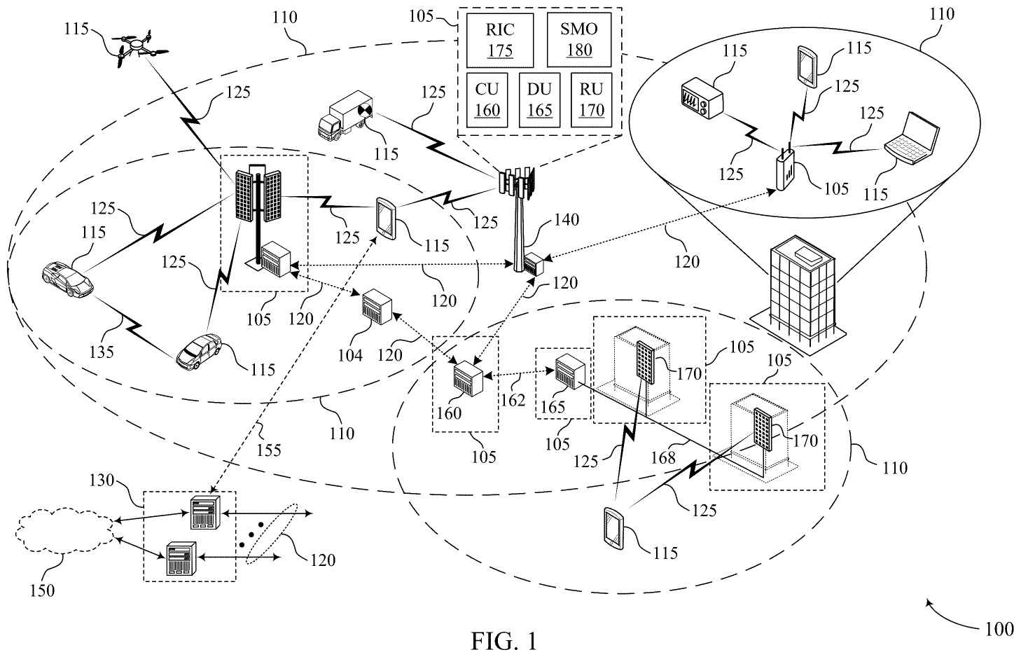

FIG. 1 shows an example of a wireless communications system 100 that supports inter uplink multiple TRPs mobility in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support inter uplink multiple TRPs mobility as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

According to techniques described herein, the network entity 105 or the UE 115 may indicate or initiate an SRS sweeping procedure based on an uplink connection quantity between the UE 115 and a first uplink TRP. The network entity 105 may transmit a control signal indicating an SRS configuration to the UE 115. The UE 115 may transmit an uplink transmission to the network entity 105. In some examples, the network entity 105 may determine to transmit an indication for the UE 115 to perform the SRS sweeping procedure based on a measurement of the uplink transmission satisfying a threshold. In some examples, the UE 115 may determine to initiate the SRS sweeping procedure based on a failure to receive a response to the uplink transmission within a response window (e.g., based on a response timer). The UE 115 may transmit one or more SRSs as part of an SRS sweeping procedure to enable the network entity 105 (e.g., the one or more TRP in communication with the network entity 105) to measure an uplink connection quality between the UE 115 and the one or more TRPs. For example, network entity 105 (e.g., the one or more TRPs in communication with the network entity 105) may perform uplink measurements on the one or more SRS transmissions to determine the uplink connection quality. The network entity 105 may initiate an uplink TRP handover procedure based on one or more measurements of the one or more SRS at the first uplink TRP or at a second uplink TRP satisfying a threshold. The network entity 105 may transmit an indication to perform an uplink TRP handover procedure from the first uplink TRP to the second uplink TRP associated with a higher connection quality based on the one or more measurements. The UE 115 may perform a RACH procedure with the second uplink TRP, and the UE 115 may transmit one or more subsequent uplink signals to the second uplink TRP.

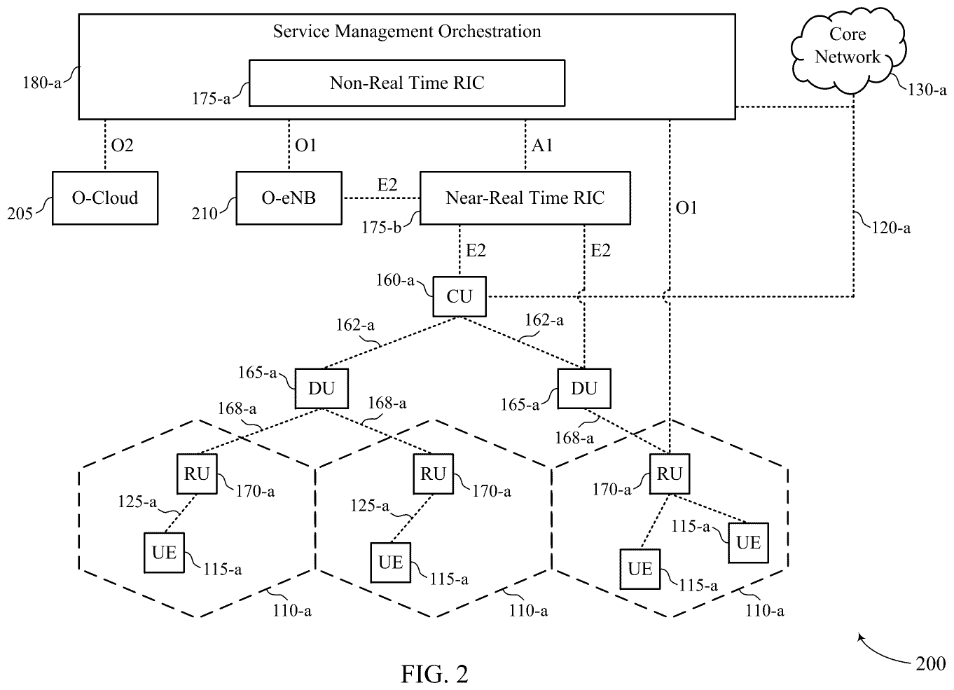

FIG. 2 shows an example of a network architecture 200 (e.g., a disaggregated base station architecture, a disaggregated RAN architecture) that supports inter uplink multiple TRPs mobility in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

According to techniques described herein, the network entity 105 or the UE 115 may indicate or initiate an SRS sweeping procedure based on an uplink connection quantity between the UE 115 and a first uplink TRP. The network entity 105 may transmit a control signal indicating an SRS configuration to the UE 115. The UE 115 may transmit an uplink transmission to the network entity 105. In some examples, the network entity 105 may determine to transmit an indication for the UE 115 to perform the SRS sweeping procedure based on a measurement of the uplink transmission satisfying a threshold. In some examples, the UE 115 may determine to initiate the SRS sweeping procedure based on a failure to receive a response to the uplink transmission within a response window (e.g., based on a response timer). The UE 115 may transmit one or more SRSs as part of an SRS sweeping procedure to enable the network entity 105 (e.g., the one or more TRP in communication with the network entity 105) to measure an uplink connection quality between the UE 115 and the one or more TRPs. For example, network entity 105 (e.g., the one or more TRPs in communication with the network entity 105) may perform uplink measurements on the one or more SRSs to determine the uplink connection quality. The network entity 105 may initiate an uplink TRP handover procedure based on one or more measurements of the one or more SRS at the first uplink TRP or at a second uplink TRP satisfying a threshold. The network entity 105 may transmit an indication to perform an uplink TRP handover procedure from the first uplink TRP to the second uplink TRP associated with a higher connection quality based on the one or more measurements. The UE 115 may perform a RACH procedure with the second uplink TRP, and the UE 115 may transmit one or more subsequent uplink signals to the second uplink TRP.

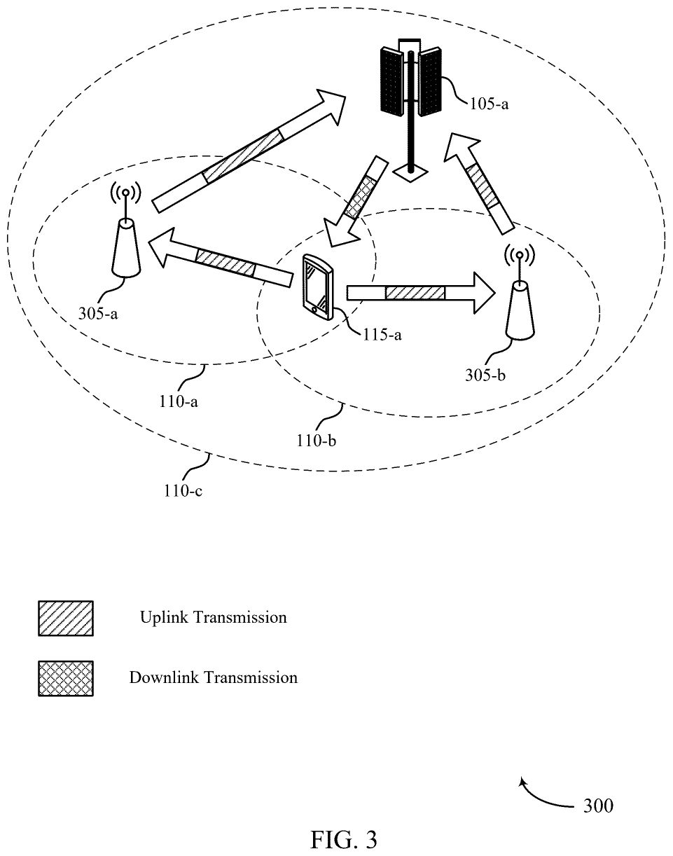

FIG. 3 shows an example of a wireless communications system 300 that supports inter uplink multiple TRPs (e.g., uplink-only cells) mobility in accordance with one or more aspects of the present disclosure. The wireless communications system 300 may implement or be implemented by various aspects of the wireless communications system 100, the network architecture 200, or both. For example, the wireless communications system 300 may include a network entity 105 and a UE 115-a which may represent examples of corresponding devices as described with reference to FIGS. 1 and 2. As described herein, the uplink multiple TRPs may be examples of or interchangeable with uplink cells (e.g., uplink-only cells).

In some wireless communications systems, an uplink TRP 305 (e.g., a first uplink TRP 305-a or a second uplink TRP 305-b) may receive uplink transmissions from multiple UEs, including the UE 115-a. A DU may include the first uplink TRP 305-a and the second uplink TRP 305-b, and the network entity 105-a may be an example of a CU or a DU, as described with reference to FIG. 2. The uplink TRP 305 may support a coverage area 110 in which the UE 115-a may transmit uplink messages to the uplink TRP 305. For example, the first uplink TRP 305-a may support the coverage area 110-a, and the second uplink TRP 305-b may support the coverage area 110-b. The coverage area 110 may be an example of an uplink coverage area, such as a micro-uplink coverage area. While the UE 115-a may be illustrated and described with reference to FIG. 3, it may be understood that more or less than UEs may be in the coverage area 110 and transmit uplink messages to the uplink TRP 305. Additionally, the first uplink TRP 305-a, the second uplink TRP 305-b, the UE 115-a, and one or more additional wireless communications devices may be in a coverage area 110-c of the network entity 105-a. The network entity 105-a may support a downlink or uplink coverage area 110-c, such as a macro-downlink or uplink coverage area. The coverage area 110-c of the network entity 105 may include one or more smaller coverage areas, including the coverage area 110-a of the first uplink TRP 305-a or the coverage area 110-b of the second uplink TRP 305-b (e.g., the micro uplink coverage area). In some examples, a first uplink TRP 305-a or the second uplink TRP 305-b may be an example of an uplink-only TRP (e.g., an uplink-only cell). In other words, the first uplink TRP 305-a or the second uplink TRP 305-b may be configured to receive uplink messages but not transmit downlink messages. The first uplink TRP 305-a or the second uplink TRP 305-b may be an example of a multiple TRP (mTRP). That is, the first uplink TRP 305-a or the second uplink TRP 305-b, while illustrated in the example of FIG. 3 as being a single TRP, may each include multiple TRPs (e.g., mTRP) or be a part of a set of multiple TRPs (e.g., a set including the first uplink TRP 305-a and the second uplink TRP 305-b).

For example, the UE 115-a may communicate with an asymmetric downlink single TRP (sTRP) (e.g., a downlink sTRP or cell collocated with or included in the network entity 105-a) and an uplink multiple transmit-receive point (mTRP) (e.g., the first uplink TRP 305-a, the second uplink TRP 305-b, or a cell). The network entity 105 may include or communicate with the asymmetric (or decoupled) downlink sTRP (e.g., a macro cell with downlink capabilities or both downlink and uplink capabilities) and the uplink mTRP (e.g., multiple uplink-only cells). The network entity 105, the UE 115-a, the first uplink TRP 505-a, and the second uplink TRP 505-b may communication via a first frequency range (FR1) or a second frequency range (FR2).

The UE 115-a may transmit an uplink transmission to the first uplink TRP 305-a or the second uplink TRP 305-b. The first uplink TRP 305-a or the second uplink TRP 305-b may forward the uplink transmission or extracted information from the received uplink transmission (e.g., measurements, an acknowledgment (ACK), or a negative acknowledgment (NACK)) to the network entity 105-a (e.g., via an ideal fronthaul link). In some examples, the network entity 105-a may transmit an synchronization signal block (SSB), channel state information (CSI) reference signal (CSI-RS) to the UE 115-a. In some examples, the UE 115-a may transmit one or more uplink transmissions (e.g., SRS, PRACH, physical uplink control channel (PUCCH), or physical uplink shared channel (PUSCH)) to the network entity 105-a.

The UE 115-a may receive downlink transmissions from the network entity 105-a. For example, there may be no downlink signal (e.g., SSB, CSI-RS, or downlink TRS transmissions) from uplink mTRPs for mobility measurement. The UE 115-a may thus be unable to perform downlink measurements from one or more uplink mTRPs to determine a channel quality between the UE 115-a and a serving uplink TRP (e.g., the first uplink TRP 305-a) or other uplink TRPs. In some cases, the UE 115-a may move away from the first uplink TRP 305-a towards the second uplink TRP 305-b. The channel quality between the UE 115-a and the first uplink TRP 305-a may deteriorate as the UE 115-a moves away from the first uplink TRP 305-a. It may be beneficial for the network entity 105-a and the UE 115-a to measure the channel quality between the UE 115-a and the first uplink TRP 305-a or other uplink TRPs and conduct a handover procedure (e.g., a cell switch) from the first uplink TRP 305-a to the second uplink TRP 305-b. As described herein, a handover procedure may be an example of or interchangeable with a cell switch procedure.

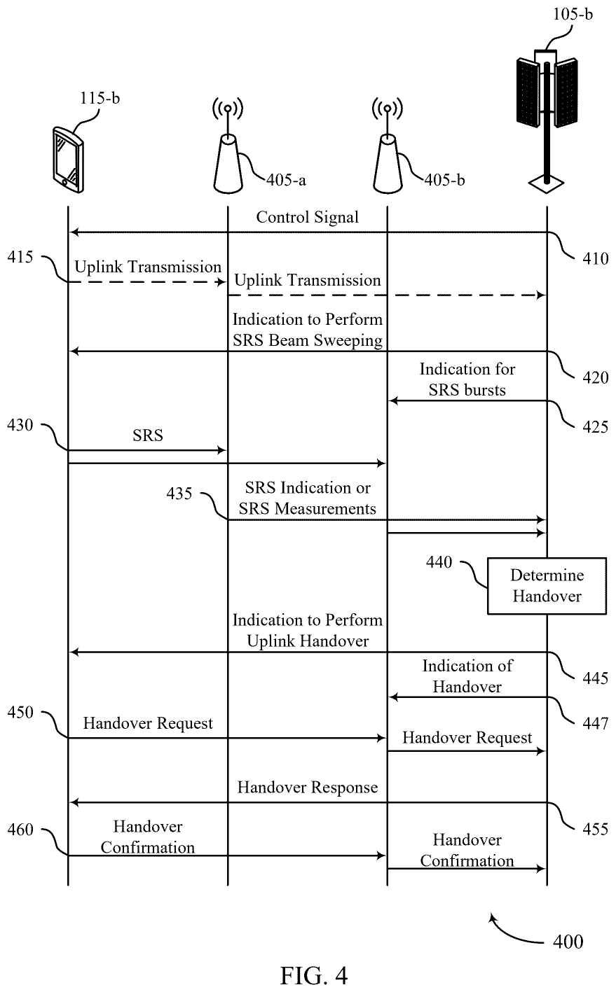

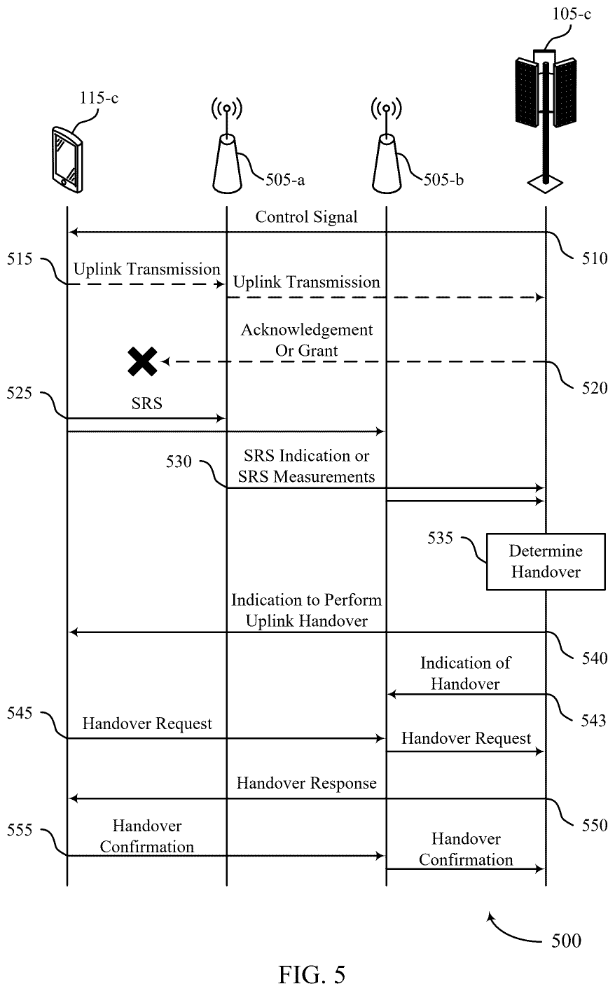

According to techniques described herein, the network entity 105-a or the UE 115-a may indicate or initiate an SRS sweeping procedure based on an uplink connection quantity between the UE 115-a and the first uplink TRP 305-a. The network entity 105-a may transmit a control signal indicating an SRS configuration to the UE 115-a. The UE 115-a may transmit an uplink transmission to the network entity 105-a. In some examples, the network entity 105-a may determine to transmit an indication for the UE 115-a to perform the SRS sweeping procedure based on a measurement of the uplink transmission satisfying a threshold, as described with reference to FIG. 4. In some examples, the UE 115-a may determine to initiate the SRS sweeping procedure based on a failure to receive a response to the uplink transmission within a response window (e.g., based on a response timer), as described with reference to FIG. 5.

The connection quality between the UE 115-a and the first uplink TRP 305-a may change based on UE mobility. For example, the UE 115-a may move away from the first uplink TRP 305-a and towards the second uplink TRP 305-b. The UE mobility may improve the connection quality between the UE 115-a and the second uplink TRP 305-b, and the UE mobility may degrade the connection quality between the UE 115-b and the first uplink TRP 305-a.

The UE 115-a may transmit one or more SRSs as part of an SRS sweeping procedure to enable the network entity 105-a (e.g., the one or more uplink TRP 305 in communication with the network entity 105-a) to collect (e.g., obtain, receive, or perform) measurements of an uplink connection quality between the UE 115-a and the one or more uplink TRPs 305. For example, the UE 115-a may transmit one or more SRSs in one or more spatial directions. The network entity 105-a (e.g., the one or more uplink TRPs 305 in communication with the network entity 105-a) may collect uplink measurements (e.g., reference signal received power (RSRP), reference signal received quality (RSRQ), or signal interference and noise ratio (SINR)) on the one or more SRSs to determine the uplink connection quality between the UE 115-a and the one or more uplink TRPs 305. The network entity 105-a may initiate an uplink TRP handover procedure based on one or more measurements of the one or more SRSs at the first uplink TRP 305-a or at a second uplink TRP 305-b satisfying a threshold. For example, a first RSRP of the first uplink TRP 305-a may satisfy a threshold (e.g., be below a threshold), a second RSRP of the second the second uplink TRP 305-b may satisfy a threshold (e.g., be above a threshold), or a difference between the first RSRP and the second RSRP may satisfy a threshold. The network entity 105-a may transmit an indication to perform an uplink TRP handover procedure or a cell switch procedure from the first uplink TRP 305-a to the second uplink TRP 305-b associated with a higher connection quality based on the one or more measurements. The UE 115-a may perform a RACH procedure or RACH-less procedure with the second uplink TRP 305-b, and the UE 115-a may transmit one or more subsequent uplink signals to the second uplink TRP 305-b.

FIG. 4 shows an example of a process flow 400 that supports inter uplink multiple TRPs mobility in accordance with one or more aspects of the present disclosure. The process flow 400 may implement or be implemented by aspects of the wireless communications system 100, the network architecture 200, or the wireless communications system 300. For example, the process flow 400 may include a UE 115-b, a first uplink TRP 405-a, a second uplink TRP 405-b, and a network entity 105-b, which may be examples of corresponding devices as described with reference to FIG. 1 -3. The first uplink TRP 505-a or the second uplink TRP 505-b may be an example of a mTRP (e.g., mTRP k and mTRP l). The network entity 105-b (e.g., a gNB or CU) may initiate an inter-uplink mTRP handover procedure for the UE 115-b.

In some cases, the UE 115-b may transmit a UE capability or UE assistance information message to the first uplink TRP 405-a. The UE capability or UE assistance information message may indicate, at least, a quantity of transmitting directions (e.g., uplink beams per panel or total beams of all panels) supported by the UE 115-b, a quantity of transmission panels included in the UE 115-b, one or more angular granularities (e.g., a minimum angular value, a maximum angular value or a range of angular values which can be used for sweeping beams), a beam switching time supported by the UE 115-b, a panel switching time supported by the UE 115-b, or any combination thereof. The first uplink TRP 405-a may forward (e.g., transmit via a fronthaul link or a midhaul link) the UE capability or UE assistance information message to the network entity 105-b.

At 410, the UE 115-b may receive, from the network entity 105-b, a control signal or message indicating a set of multiple TRPs associated with the network entity 105-b (e.g., the first uplink TRP 405-a or the second uplink TRP 405-b). For example, the control signal or message may indicate a list of multiple uplink TRPs (or cells) including the identifiers (IDs) or indexes of TRPs (or cells), associated frequencies of TRPs (or cells), or the ranks or priorities of TRPs (or cells). Additionally, or alternatively, a control signal or message may indicate an SRS configuration for an uplink handover procedure or cell switch procedure associated with the set of multiple uplink TRPs (or cells). The SRS configuration may indicate one or more SRS resource sets for one or more SRS beam sweeping bursts (e.g., a SRS transmission pattern or SRS transmission resource structure in time, such as symbols or slots). The one or more SRS resource sets may be based on the UE capability or UE assistance information message as described herein. In some examples, an SRS resource set may be configured for an SRS sweeping burst covering a wide spatial directional area or a wide angular range (e.g., a relatively large quantity of directions or beams, a relatively large angular granularity, or wide beams). In some examples, an SRS resource set may be configured for an SRS sweeping burst covering a narrow spatial directional area or a narrow angular range (e.g., a relatively small quantity of directions or beams, a relatively small angular granularity, or narrow beams). In some examples, an SRS resource set may be configured for a sweeping burst with a relatively long duration (e.g., a burst with symbols across one or more slots). In some examples, an SRS resource set may be configured for an SRS sweeping burst with a relatively short duration (e.g., a burst with relatively few symbols in a slot). In some examples, an SRS resource set may be configured for a quantity of sweeping bursts with a relatively long cycle or periodicity. In some examples, an SRS resource set may be configured for a quantity of SRS sweeping bursts with a relatively short cycle or periodicity (e.g., a burst with a few symbols in a slot).

For example, network entity 105-b may transmit a configuration for asymmetric downlink and uplink (e.g., decoupled downlink or uplink) which may include: a configuration for downlink and uplink TRP (e.g., the network entity 105-b), one or more configurations for uplink mTRPs (e.g., the first uplink TRP 405-a and the second uplink TRP 405-b), or an SRS configuration indicating one or more SRS resource sets for uplink measurements (e.g., via one or more SRS sweeping bursts). The SRS resource sets may each include SRS resources for an SRS sweeping burst at the UE 115-b. The SRS resources may include SRS resource indications associated with respective time allocations including one or more slots or one or more symbols in a slot and a respective frequency allocations including one or more PRBs) for an SRS sweeping burst at the UE 115-b. In some examples, the configuration for asymmetric downlink and uplink (e.g., decoupled downlink or uplink) may include transmit power information. For example, the network entity 105-b may also configure the transmit power associated with the one or more SRS resources sets. The network entity 105-b may configure one or more incremental step sizes of the transmit power for one or more SRS sweeping bursts (e.g., for SRS weeping repetition or for different uplink mTRPs).

In some aspects, the UE 115-b may receive, from the network entity 105-b, a control signal or a message indicating a set of mTRPs associated with the network entity 105-b (e.g., the first uplink TRP 405-a or the second uplink TRP 405-b). For example, the control signal or the message may activate or deactivate one or more uplink mTRPs (or cells) of the set of mTRPs. The control signal or the message may include: the IDs or indexes of TRPs (or cells), associated frequencies of TRPs (or cells), or the ranks or priorities of TRPs (or cells). Additionally, or alternatively, the control signal or the message may activate or deactivate an SRS configuration for an uplink handover procedure or cell switch procedure associated with the set of uplink mTRPs (or cells). The activation or deactivation of SRS configurations may indicate: one or more SRS configuration IDs, indexes of the SRS configurations, or one or more SRS resource sets (e.g., SRS set IDs or indexes) for one or more SRS beam sweeping bursts. In some examples, the network entity may transmit the control signal or the message for activation or deactivation of the mTRPs via MAC control element (MAC-CE).

At 415, the UE 115-b may transmit, to the first uplink TRP 305-a, a scheduled uplink transmission. The first uplink TRP 305-a may forward the scheduled uplink transmission to the network entity 105-b or the extracted result of the uplink transmission (e.g., layer 1 or layer 3 measurements, ACK or NACK, or the like).

At 420, the UE 115-b may receive, from the network entity 105-b based on the scheduled uplink transmission, a second control signal or message corresponding to the scheduled uplink transmission. For example, the second control signal or message may indicate an ACK or NACK for the received uplink transmission. Additionally, or alternatively, the second control signal or message may indicate to perform SRS beam sweeping in accordance with the one or more SRS resource sets for the SRS beam sweeping procedure. In some examples, the network entity 105-b may transmit a MAC-CE to activate an SRS resource set (e.g., for an SRS sweeping burst with a relatively short duration or an SRS sweeping burst covering a relatively narrow spatial directional area or angular range) of one or more SRS resource sets configured for one or more SRS sweeping bursts (e.g., one or more SRS sweeping patterns or structures). The UE 115-b may receive a MAC-CE indicating an activation of an SRS resource set associated with the one or more SRS resource sets for the SRS beam sweeping burst. In some examples, the network entity 105-b may transmit a downlink control information (DCI) including an indication of one or more SRS sweeping bursts (e.g., including an SRS resource set ID or index for an SRS sweeping burst pattern or structure or a quantity of SRS sweeping repetitions). The UE 115-b may receive a MAC CE or DCI including at least an ID or index of an SRS resource set associated with the one or more SRS resource sets or a quantity of repetitions (e.g., repeated with the same directional sweeping bursts) or a quantity of bursts (e.g., same or different directional sweeping bursts). For example, the quantity of bursts may include a first burst associated with a first panel or a first spatial directional area and a second burst associated with a second panel or a second spatial directional area. Additionally, or alternatively, the MAC CE or DCI may include a starting point, a duration, or a ending point of the one or more SRS bursts, for bursts associated with the SRS beam sweeping procedure. The second control signal or message may include a starting point (e.g., a first slot and or a first symbol within the first slot) or an indication of SRS resources (e.g., an initial SRS resource indication for an initial SRS resource) for an SRS beam sweeping procedure at the UE 115-b. Additionally, or alternatively, the second control signal or message may indicate a duration (e.g., in a quantity of slots or symbols, or a range or list of SRS resource indications), an ending point (e.g., a last slot and or a last symbol within the last slot), or an indication of SRS resources (e.g., the last SRS resource indication for a last SRS resource) for an SRS beam sweeping procedure at the UE 115-b, or any combination thereof. Additionally, or alternatively, the second control signal or message may include a directional reference for starting an SRS (e.g., a beam direction referenced from an SSB or CSI-RS of the network entity 105-b or an SRS towards to the current uplink TRP). Additionally, or alternatively, the network entity 105-b may indicate a transmit power associated with the SRS sweeping. The transmit power may include an incremental step size of the transmit power for one or more SRS sweeping bursts (e.g., for SRS sweeping repetition).

The network entity 105-b may transmit the second control signal or message based on one or more measurements (e.g., RSRP, RSRQ, or SINR) of the received uplink transmission to the first uplink TRP 305-a (e.g., mTRP k), or a missed decoding or reception of the scheduled uplink transmission at the first uplink TRP 305-a (e.g., mTRP k). For example, the network entity 105-b may transmit the second control signal or message based on the one or more measurements satisfying a threshold (e.g., the RSRP, RSRQ, or SINR may be below or above a threshold value).

At 425, the network entity 105-b may transmit an indication to (e.g., activate) one or more uplink TRPs 405 for monitoring the one or more SRS sweeping bursts. For example, the network entity 105-b may transmit the indication with an activation signal to the second uplink TRP 405-b indicating a duration (e.g., a duration for monitoring the one or more the SRS sweeping bursts) to remain activated corresponding to an SRS procedure at the UE 115-b. For example, the network entity 105-b may transmit the indication including a monitoring window for the one or more SRS sweeping bursts, the sweeping structure or pattern (e.g., symbols and/or slots corresponding to SRS transmissions associated with one or more SRS sweeping bursts), or a threshold for selecting one or more SRSs (e.g., associated with the one or more measurement satisfying the threshold).

At 430, the UE 115-b may transmit one or more SRSs via one or more SRS resources associated with the one or more SRS resource sets in accordance with the SRS beam sweeping burst (e.g., based on the SRS configuration received at 410 or the SRS sweeping indication received at 420). The UE 115-b may sweep SRS transmissions at multiple resources associated with respective spatial directions. For example, the UE 115-b may transmit a first SRS (e.g., SRS k at SRS resource k) in a first direction to the first uplink TRP 405-a (e.g., spatial direction k to mTRP k), and the UE 115-b may transmit a second SRS (e.g., SRS l. at SRS resource l) in a second direction to the second uplink TRP 405-b (e.g., spatial direction l. to mTRP l). The first uplink TRP 405-a and the second uplink TRP 405-b may each be expected to receive one or more SRSs (e.g., the first SRS at the first uplink TRP 405-a and the second SRS at the second uplink TRP 405-b). The UE 115-b may transmit the one or more SRS transmissions over a quantity of symbols (e.g., six symbols) corresponding to a quantity of spatial directions (e.g., six spatial directions) or beams (e.g., six uplink beams). For example, the quantity of symbols may be based on the SRS sweeping structure or pattern which may be configured with the SRS configuration (e.g., including the configuration of one or more SRS resource sets) received at 410 or the SRS sweeping indication (e.g., indicating one or more SRS resource sets) received at 420). The SRS beam sweeping structure or pattern may include a gap. The gap may be an empty symbol between adjacent SRS transmissions (e.g., for beam switching and/or panel switching). In some examples, the UE 115-b may start the SRS sweeping (e.g., the first SRS transmission of an SRS sweeping burst) in a spatial direction associated with (e.g., type D quasi co-located (QCL)) a selected SSB (e.g., best SSB) transmitted from the network entity 105-b. In some examples, the UE 115-b may start the SRS sweeping (e.g., the first SRS transmission of an SRS sweeping burst) in a spatial direction associated with the current or serving CSI-RS (e.g., type D QCL) transmitted from the network entity 105-b. In some examples, the UE 115-b may start a first SRS sweeping burst from a first spatial direction (e.g., a first uplink beam) of a first panel, and/or the UE 115-b may start a second SRS sweeping burst from a second spatial direction (e.g., a second uplink beam) of a second panel associated with a same or different SRS resource sets. In some examples, the UE 115-b may start an SRS sweeping burst with one or more spatial directions of a first panel and then with one or more spatial directions of a second panel with one SRS resource set. For example, the UE 115-b may initiate (e.g., transmit) one or more SRS sweeping burst using the transmit power indicated by the network entity 105-b. For example, the UE 115-b may start a first SRS sweeping burst using the transmit power indicated by the network entity 105-b and a second SRS sweeping burst using a transmit power in accordance with a summation of the previous transmit power and the incremental step size of the transmit power as indicated by the network entity 105-b.

At 435, the first uplink TRP 405-a and the second uplink TRP 405-b may may forward the one or more received SRSs or one or more measurements or one or more selected SRS beam corresponding to the one or more received SRS (e.g., RSRP, RSRQ, or SINR) to the network entity 105-b. For example, the uplink TRP 405 (e.g., the first uplink TRP 405-a or the second uplink TRP 405-b) may detect and measure a first SRS and a second SRS, and the uplink TRP 405 may transmit an indication of the measurements of at least the first or the second SRS or both to the network entity 105-b. Additionally, or alternatively, the uplink TRP 405 may transmit an indication of the one or more received SRS beams associated with the measurements where the SRS beam may be indicated via an SRS index associated with a received SRS transmission (e.g., an index indicated in the SRS sequence) or via an SRS resource index or indication (e.g., an SRS resource i associated with an SRS transmission received at the ith symbol or resource allocation of the SRS sweeping burst).

At 440, the network entity 105-b may determine a handover or cell switch to the second uplink TRP 405-b based on the SRS measurements. For example, the network entity 105-b may determine, based on the SRS measurements, that a first communication link between the second uplink TRP 405-b and the UE 115-b is more reliable than a second communication link between the first uplink TRP 405-a and the UE 115-b. The network entity 105-b may determine a handover to the second uplink TRP 405-b based on one or more measurements of the SRS measurements exceeding (e.g., satisfying) a threshold (e.g., the measurement of the first communication link is above a first threshold, the measurement of the second communication link is below a second threshold, the measurement of the first communication link indicate a more reliable communications link than (is better than) the measurement of the second communication link, or the difference between the measurement of the first communication link and the measurement of the first communication link is above a threshold).

At 445, the UE 115-b may receive, based on the one or more SRSs, an indication to perform the uplink handover procedure from a first uplink TRP of the set of multiple uplink TRPs to a second uplink TRP of the set of multiple uplink TRPs. For example, the network entity 105-b may transmit an implicit handover indication. The indication to perform the uplink handover procedure may include a physical downlink control channel (PDCCH) order PRACH message or a RRC reconfiguration message. In some examples (e.g., if the UE 115-b has received uplink configuration (e.g., for handover or cell switch) such as RACH configuration or configured grant configuration for the second uplink TRP 405-b), the network entity 105-b may transmit a PDCCH order for a RACH procedure with the second uplink TRP 405-b (e.g., an implicit RACH based handover to the second uplink TRP 405-b using an uplink beam associated to an SRS transmission (e.g., best SRS beam ID or index or SRS resource indication as indicated in the PDCCH order based PRACH) of the one or more SRS sweeping bursts) or a PDCCH for a configured grant (e.g., activating a type 2 configured grant or indicating a type 1 configuration index) with the second uplink TRP 405-b (e.g., an implicit RACH-less based handover or cell switch to the second uplink TRP 405-b using an uplink beam associated to an SRS transmission of the one or more SRS sweeping bursts (e.g., best SRS beam ID or index or SRS resource indication as indicated in the PDCCH for RACH-less procedure)). In some examples (e.g., if the UE 115-b has not received uplink configuration such as RACH configuration or configured grant configuration for the second uplink TRP 405-b), the network entity 105-b may transmit an RRC reconfiguration message indicating an uplink configuration (e.g., a RACH configuration or configured grant configuration) for the second uplink TRP 405-b. The RRC reconfiguration message may be an implicit indication to trigger the UE 115-b to start a RACH based handover using the received RACH configuration or a RACH-less based handover using the received configured grant configuration (e.g., type 1 configured grant) on an uplink beam associated to an SRS transmission of the one or more SRS sweeping bursts. In some examples, the network entity 105-b may transmit a MAC-CE to activate an uplink configuration (e.g., a RACH configuration and/or resources or configured grant configuration or resources) for the second uplink TRP 405-b. The MAC-CE may be an implicit indication to trigger the UE 115-b to start a RACH based handover using one or more activated RACH resources or a RACH-less based handover using one or more activated configured grant resources on an uplink beam associated to an SRS transmission of the one or more SRS sweeping bursts.

In some examples, the UE 115-b may receive, based on the one or more SRSs, an indication to perform the uplink handover procedure or cell switch procedure from a first uplink TRP of the set of multiple uplink TRPs to a second uplink TRP of the set of multiple uplink TRPs. For example, the network entity 105-b may transmit an explicit handover command to perform the uplink handover procedure from a source uplink TRP to a target uplink TRP (e.g., from the first uplink TRP 405-a to the second uplink TRP 405-b). The explicit handover command may include the source or target uplink TRP (e.g., an ID or an index of the first uplink TRP 405-a or an ID or an index of the second uplink TRP 405-b), an indication of resources for RACH based or RACH-less based handover, or an indication of an uplink beam (e.g., SRS ID or index or SRS resource indication).

In some examples, the uplink beam or the spatial direction may be indicated by a transmission configuration indicator (TCI) state. In some examples, the uplink beam or spatial direction may be QCL with a downlink TCI state referenced from an SSB (e.g., an SSB index) or CSI-RS (e.g., CSI-RS index or resource indication) transmitted from the network entity 105-b. In some examples, the uplink beam or spatial direction may be QCL with an uplink TCI state associated with an SSB or CSI-RS transmitted from the network entity 105-b. In some examples, the uplink beam or spatial direction may be QCL with an uplink SRS (e.g., SRS index or SRS resource indication) transmitted from the UE 115-b (e.g., based on an SRS transmission received and selected for the target uplink TRP, such as the second uplink TRP 405-b, of the one or more SRS sweeping bursts as described at 435). In some examples, the uplink beam or the spatial direction may be indicated by a spatial relationship (e.g., spatial filter or QCL with a downlink SSB (SSB index) or CSI-RS (CSI-RS index or resource indication) transmitted from the network entity 105-b or an uplink SRS (e.g., SRS index or SRS resource indication) transmitted from the UE 115-b (e.g., based on an SRS transmission received and selected for the target uplink TRP (e.g., the second uplink TRP 405-b) of the one or more SRS sweeping bursts as described in details at 435)), or any combination thereof.

Additionally, or alternatively, the network entity 105 b may indicate a timing advance (TA) value associated with the second uplink TRP 405-b. The network entity 105-b may derive the TA value from the SRS sweeping. For example, the network entity 105-b may derive the TA value for the RACH-less handover or the cell switch.

At 447, the uplink TRP may receive, based on the one or more SRSs, an indication of an uplink handover from a first uplink TRP of the set of multiple uplink TRPs to a second uplink TRP of the set of multiple uplink TRPs. For example, the network entity 105-b may transmit an handover indication to the first uplink TRP 405-a or the second uplink TRP 405-b. The indication may indicate the monitoring window for RACH based handover or RACH-less based handover (e.g., the resources in time and frequency for monitoring a handover request or indication on a RACH message 1 or an uplink transmission on configured grant, the spatial direction or spatial filter, the preamble sequence, or the ID of the UE 115-b (e.g., a temporary ID or C-RNTI).

At 450, the UE 115-b may transmit, to the second uplink TRP 405-b, a hand over or connection request or indication via a random access message (e.g., message 1 of RACH procedure) including a dedicated preamble sequence or a selected preamble sequence based on the indication to perform the uplink handover procedure using dedicated (e.g., contention free RACH) or a shared configuration (e.g., contention based RACH). The random access message may indicate an uplink handover or connection indication. In some examples, the UE 115-b may transmit a RACH message 1 that includes a preamble sequence based on the received handover indication or cell switch indication. The preamble sequence may be dedicated to the handover for uplink TRP (e.g., an implicit indication of handover). In some examples, the UE 115-b may transmit, based on the received handover indication, a RACH message 1 at one or more resources which may be dedicated to the handover for uplink TRP (e.g., an implicit indication of handover). Additionally, or alternatively, a cause of the RACH message 1 may be set as uplink connection (e.g., an explicit indication of handover or connection). In some examples, the preamble sequence may be a dedicated preamble sequence associated with time and frequency resources with contention free RACH for uplink TRP handover or cell switch. The dedicated preamble sequence may be configured to indicate the uplink handover procedure. In other words, the network entity 105-b may allocate the dedicated preamble sequence for a RACH message 1 on dedicated or shared RACH resources of an uplink TRP handover procedure. In some examples, the preamble sequence may be a preamble sequence associated with shared time and frequency resources with contention based RACH resources. The second uplink TRP 405-b may forward the received RACH message 1 or the decoded (e.g., extracted) information of the received RACH message 1 to the network entity 105-b. In some examples, the UE 115-b may transmit, to the second uplink TRP 405-b, multiple hand over or connection requests or indications via multiple random access message transmissions (e.g., repetition). The multiple random-access message transmission may include a dedicated preamble sequence or a selected preamble sequence based on the indication to perform the uplink handover procedure using dedicated RACH occasions (e.g., contention free RACH occasions) or a shared RACH occasions (e.g., contention based RACH occasions) using a same or different SRS beams.

In some examples, the UE 115-b may transmit, to the second uplink TRP 405-b, a handover or connection indication or confirmation for the RACH-less uplink handover procedure or cell switch procedure via PUSCH based on configured grant (e.g., the message 3 of RACH procedure using the TA indicated by the network entity 105-b via the handover or cell switch indication as described with at 445). For example, the configured grant may be dedicated to uplink handover indication or confirmation (e.g., an implicit indication of handover indication or confirmation). For example, the configured grant may be shared for uplink transmission and the uplink handover indication using the configured grant may include an indication for uplink hand over (e.g., an explicit indication of handover indication or confirmation). Additionally, or alternatively, the uplink handover indication or confirmation may include the source TRP ID or index or the target TRP ID or index, or the UE ID (e.g., a temporary ID or C-RNTI). In some examples, the UE 115-b may transmit, to the second uplink TRP 405-b, multiple handover or connection indications or confirmation for the uplink handover procedure via PUSCH based on the configured grant (e.g., at multiple configured grant transmission occasions) using the same or different SRS beams. For example, the handover or connection indications or confirmation may be included in a MAC CE or an RRC (e.g., RRCReconfigurationComplete).

At 455, for RACH based handover or cell switch, the network entity 105-b may receive, from the network entity 105-b, a response to the uplink handover or connection request or indication via random access response (RAR) (e.g., message 2 of RACH procedure) indicating a TA value associated with the second uplink TRP 405-b or a MAC-CE indicating a TA adjustment associated with the second uplink TRP 405-b. For example, the network entity 105-b may transmit a RACH message 2 as a response (e.g., a RAR including the TA for the second uplink TRP 405-b). For example, the network entity 105-b may transmit a MAC-CE for TA adjustment (e.g., a MAC-CE including the TA adjustment for the second uplink TRP 405-b). Additionally, the handover response may include a UE ID (e.g., a temp ID or C-RNTI).

At 460, for RACH based handover or cell switch, the UE 115-b may transmit, to the second uplink TRP 405-b, a handover confirmation via a second random access message (e.g., message 3 of RACH procedure) indicating the confirmation of the uplink handover or cell switch procedure and in accordance with the TA value. For example, the UE 115-b may transmit an implicit handover confirmation. In some examples (e.g., if the UE 115-b received a PDCCH RACH), the UE 115-b may transmit a RACH Message 3 using the indicated TA in the received RAR in response to the PDCCH RACH. In some examples (e.g., if the UE 115-b received a MAC-CE with TA adjustment), the UE 115-b may transmit an ACK or NACK in response to the MAC-CE with the adjusted TA. In some examples (e.g., if the UE 115-b received a RRC reconfiguration message), the UE 115-b may transmit a RRC reconfiguration complete message in response to the RRC reconfiguration message. The second uplink TRP 405-b may forward the received implicit handover confirmation to the network entity 105-b. For example, the UE 115-b may transmit an explicit handover confirmation via an RRC message or a MAC-CE on PUSCH as indicated in the handover response message at 455. The explicit handover confirmation may include the received UE ID (e.g., a temp ID or C-RNTI received at 455).

In some examples, the network entity 105-b may indicate handover confirmation to the source TRP (e.g., the first uplink TRP 405-a) to cause the source TRP to release the dedicated configurations for the UE 115-b. In some examples, the network entity 105-b may indicate handover confirmation to the target TRP (e.g., the second uplink TRP 405-b) to cause (e.g., enable) the target TRP to set up the dedicated configurations for the UE 115-b.

FIG. 5 shows an example of a process flow 500 that supports inter uplink multiple TRPs mobility in accordance with one or more aspects of the present disclosure. The process flow 500 may implement or be implemented by aspects of the wireless communications system 100, the network architecture 200, the wireless communications system 300, or the process flow 400. For example, the process flow 500 may include a UE 115-c, a first uplink TRP 505-a, a second uplink TRP 505-b, and a network entity 105-c, which may be examples of corresponding devices as described with reference to FIG. 1-4. The network entity 105-c may be an example of a gNB or CU (or a cell with downlink only capabilities or both downlink and uplink capabilities). The first uplink TRP 505-a or the second uplink TRP 505-b may be an example of a mTRP (e.g., mTRP k and mTRP l) (or a cell with uplink-only). The UE 115-c may initiate an inter-uplink mTRP handover (or inter-uplink cell switch) procedure.

In some cases, the UE 115-c may transmit a UE capability or UE information message to the first uplink TRP 505-a. The UE capability or UE information message may indicate a quantity of transmitting directions supported by the UE 115-c, a quantity of transmission panels included in the UE 115-c, or an angle range supported by the UE 115-c as described herein with reference to FIG. 4. The first uplink TRP 505-a may forward the UE capability or UE information message to the network entity 105-c.

At 510, the UE 115-c may receive, from the network entity 105-c, a control signal indicating a set of multiple TRPs associated with the network entity 105-c (e.g., the first uplink TRP 505-a or the second uplink TRP 505-b) and an SRS configuration for an uplink handover procedure or cell switch procedure associated with the set of multiple uplink TRPs. The SRS configuration may indicate one or more SRS resource sets for an SRS beam sweeping procedure.

For example, network entity 105-c may transmit a configuration for asymmetric downlink and uplink (e.g., decoupled downlink and uplink cells) which may include: a downlink and uplink TRP (e.g., the network entity 105-c with downlink capabilities or both downlink and uplink capabilities), one or more uplink mTRPs (e.g., the first uplink TRP 505-a and the second uplink TRP 505-b), or one or more SRS sets for uplink measurements, as described herein with reference to FIG. 4 (e.g., at 410).

At 515, the UE 115-c may transmit, to the first uplink TRP 505-a, an uplink transmission. A response timer may be initiated based on the uplink transmission. For example, the UE 115-c may send a non-scheduled uplink transmission to the first uplink TRP 505-a. The UE 115-c may transmit the non-scheduled uplink transmission without receiving scheduling information (e.g., a grant) from the network entity 105-c (e.g., a configured grant transmission or a RACH message 1 transmission based on the configuration). The first uplink TRP 305-a may forward the non-scheduled uplink transmission or extracted result of the uplink transmission to the network entity 105-c.

At 520, the network entity 105-c may be expected to transmit a response (e.g., a DCI or MAC CE) to the non-scheduled uplink transmission. In some examples, the network entity 105-c may transmit an ACK or a grant for retransmission in response to the UE initiated uplink transmission (e.g., RACH message 1 or a PUSCH (e.g., RACH message 3) based on the configured grant). In some examples, the network entity 105-c may transmit an RAR message in response to the RACH message 1 transmission or an explicit or implicit ACK or NACK for the PUSCH transmission an explicit ACK or NACK included in a DCI or MAC-CE or an implicit ACK indicated via the same HARQ process ID and toggled NDI for an initial transmission of a new transport block (TB) or an implicit NACK via the same HARQ process ID and non-toggled NDI for a retransmission of the same TB). In some cases, the UE 115-c may not receive the response to the uplink transmission based on the first uplink TRP 505-a or the network entity 105-c not receiving the uplink transmission. In some cases, the UE 115-c may fail to decode the response to the uplink transmission.

At 525, the UE 115-c may determine and transmit one or more SRSs via one or more SRS resources associated with the one or more SRS resource sets in accordance with the SRS beam sweeping burst configuration, as described herein with reference to FIG. 4 (e.g., at 410 and 420)). For example, the UE 115-c may determine to perform a sweep SRS based on missing the response from the network entity 105-c (e.g., after the response timer expires). In other words, the UE 115-c may perform the SRS beam sweeping procedure, as described herein with reference to FIG. 4 (e.g., at 430), via the one or more SRS resource sets based on a failure to receive a response to the uplink transmission and an expiration of the response timer. The UE 115-c may transmit a first SRS (e.g., SRS k) in a direction of the first uplink TRP 505-a (e.g., mTRP k), and the UE 115-b may transmit a second SRS (e.g., SRS l) in a direction of the second uplink TRP 505-b (e.g., mTRP l) after the response timer expires. The first uplink TRP 505-a and the second uplink TRP 505-b may each receive one or more SRSs (e.g., the first SRS and the second SRS). The UE 115-c may transmit the one or more SRS over a quantity of symbols (e.g., six symbols). The SRS beam sweeping procedure may include an empty symbol between each SRS transmission (e.g., for beam switching). At 530, the first uplink TRP 505-a and the second uplink TRP 505-b may may forward the one or more received SRSs or one or more measurements corresponding to the one or more received SRS (e.g., RSRP, RSRQ, or SINR) to the network entity 105-c. For example, the first uplink TRP 505-a may measure the first SRS and the second SRS, and the first uplink TRP 505-a may transmit an indication of the measurements to the network entity 105-c, as described herein with reference to FIG. 4 (e.g., at 435).

At 535, the network entity 105-c may determine a handover to the second uplink TRP 505-b based on the SRS measurements. For example, the network entity 105-c may determine, based on the SRS measurements, that a first communication link between the second uplink TRP 505-b and the UE 115-c is more reliable than a second communication link between the first uplink TRP 505-a and the UE 115-c. The network entity 105-c may determine the handover to the second uplink TRP 505-b based on one or more measurements of the SRS measurements exceeding a threshold, as described herein with reference to FIG. 4 (e.g., at 440).

At 540, the UE 115-c may receive, based on the one or more SRSs, an indication to perform the uplink handover procedure or cell switch procedure from a first uplink TRP of the set of multiple uplink TRPs to a second uplink TRP of the set of multiple uplink TRPs, as described herein with reference to FIG. 4 (e.g., at 445). For example, the network entity 105-c may transmit an implicit handover indication. The indication to perform the uplink handover procedure may include a PDCCH order PRACH message or a RRC reconfiguration message. In some examples (e.g., if the SRS configuration includes a configuration for the second uplink TRP 505-b), the network entity 105-c may transmit a PDCCH order for a RACH procedure with the second uplink TRP 505-b. In some examples (e.g., if the SRS configuration does not include a configuration for the second uplink TRP 505-b), a RRC reconfiguration message for the second uplink TRP 505-b

At 543, the uplink TRP may receive, based on the one or more SRSs, an indication of an uplink handover from a first uplink TRP (e.g., the first uplink TRP 505-a) of the set of multiple uplink TRPs to a second uplink TRP (e.g., the second uplink TRP 505-b) of the set of multiple uplink TRPs, as described herein with reference to FIG. 4 (e.g., at 447).

At 545, The UE 115-c may transmit, to the second uplink TRP 505-b, a handover indication via a random access message including a dedicated preamble sequence or a contention based preamble sequence based on the indication to perform the uplink handover procedure, as described herein with reference to FIG. 4 (e.g., at 450). The random access message may indicate the uplink handover procedure. For example, the UE 115-c may transmit a RACH message 1 using a preamble sequence based on the received handover indication. A cause of the RACH message 1 may be set as uplink connection. In some examples, the preamble sequence may be a dedicated preamble sequence associated with time and frequency resources with contention free RACH. The dedicated preamble sequence may be configured to indicate the uplink handover procedure. In other words, the network entity 105-c may allocate the dedicated preamble sequence for a RACH message 1 of an uplink TRP handover procedure. In some examples, the preamble sequence may be a preamble sequence associated with shared time and frequency resources with contention based RACH. The second uplink TRP 505-b may forward the received RACH message 1 or the decoded (e.g., extracted) information of the received RACH message 1 to the network entity 105-c.

In some examples, the UE 115-c may transmit, to the second uplink TRP 505-b, a handover request or indication for the uplink handover procedure using PUSCH based on configured grant, as described herein with reference to FIG. 4 (e.g., at 450).

At 550, the network entity 105-c may receive, from the network entity 105-c, a RAR indicating a TA value associated with the second uplink TRP 505-b, as described herein with reference to FIG. 4 (e.g., at 455). For example, the network entity 105-c may transmit a RACH message 2 as a response (e.g., a RAR including the TA for the second uplink TRP 505-b).

At 555, the UE 115-c may transmit, to the second uplink TRP 505-b, a second random access message indicating confirmation of the uplink handover procedure and in accordance with the TA value, as described herein with reference to FIG. 4 (e.g., at 460). For example, the UE 115-c may transmit an implicit handover confirmation. In some examples (e.g., if the UE 115-c received a PDCCH RACH), the UE 115-c may transmit a RACH Message 3 in response to the PDCCH RACH. In some examples, (e.g., if the UE 115-c received a RRC reconfiguration message), the UE 115-c may transmit a RRC reconfiguration complete message in response to the RRC reconfiguration message. The second uplink TRP 505-b may forward the received implicit handover confirmation to the network entity 105-c.

In some examples, the network entity 105-c may indicate handover confirmation to the source TRP (e.g., the first uplink TRP 505-a) to cause the source TRP to release the dedicated configurations for the UE 115-c. In some aspects, the network entity 105-c may indicate handover confirmation to the target TRP (e.g., the second uplink TRP 505-b) to cause the target TRP to set up the dedicated configurations for the UE 115-c.

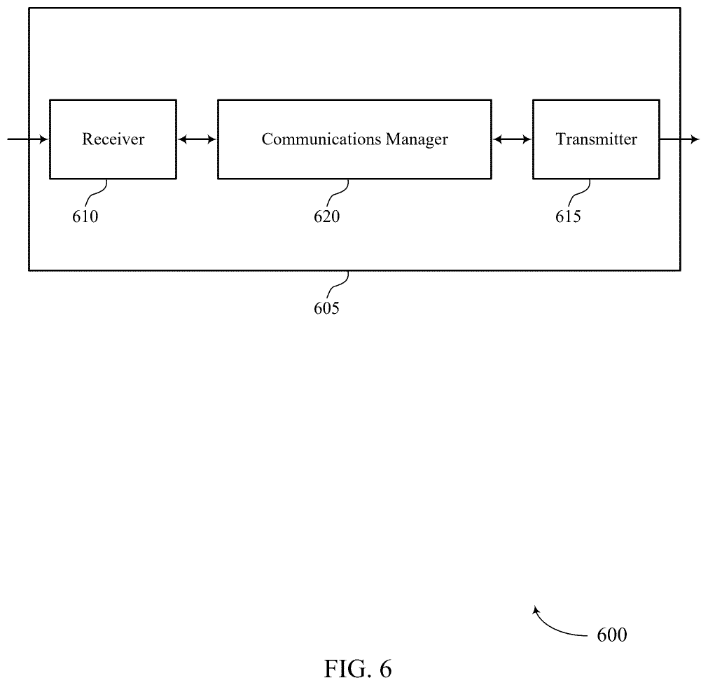

FIG. 6 shows a block diagram 600 of a device 605 that supports inter uplink multiple TRPs mobility in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. The device 605 may also include one or more processors, memory coupled with the one or more processors, and instructions stored in the memory that are executable by the one or more processors to enable the one or more processors to perform the uplink TRP handover procedure features discussed herein. Each of these components may be in communication with one another (e.g., via one or more buses).

The receiver 610 may provide a means for receiving information such as packets, user data, control information, or any combination thereof associated with various information channels (e.g., control channels, data channels, information channels related to inter uplink multiple TRPs mobility). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to inter uplink multiple TRPs mobility). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of inter uplink multiple TRPs mobility as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication in accordance with examples as disclosed herein. For example, the communications manager 620 is capable of, configured to, or operable to support a means for receiving, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure. The communications manager 620 is capable of, configured to, or operable to support a means for transmitting one or more SRSs via one or more SRS resources associated with the one or more SRS resource sets in accordance with the SRS beam sweeping procedure. The communications manager 620 is capable of, configured to, or operable to support a means for receiving, based on the one or more SRSs, an indication to perform the uplink handover procedure from a first uplink TRP of the set of multiple uplink TRPs to a second uplink TRP of the set of multiple uplink TRPs.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources and the like.

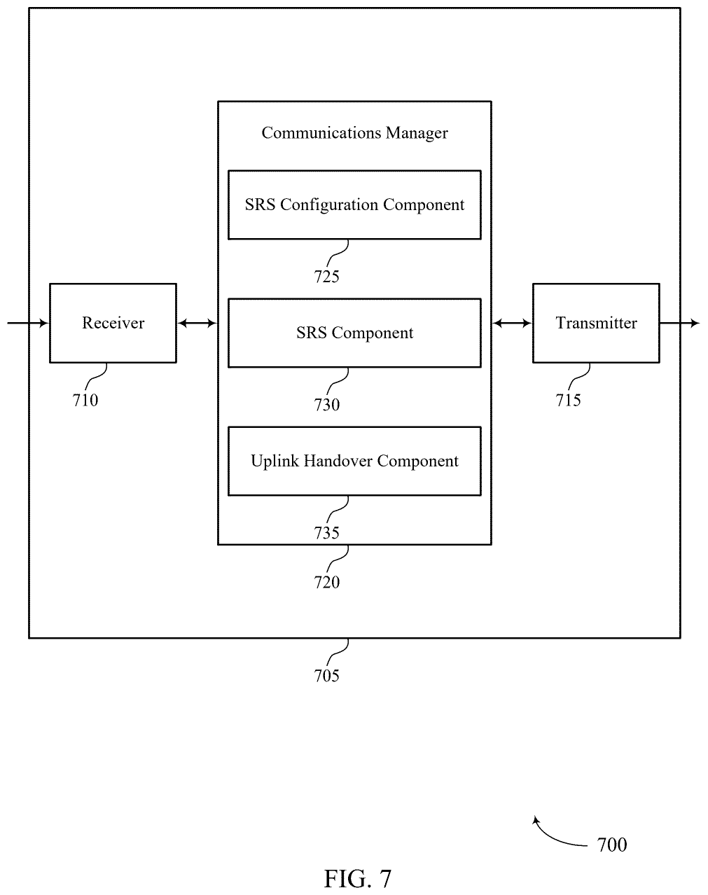

FIG. 7 shows a block diagram 700 of a device 705 that supports inter uplink multiple TRPs mobility in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to inter uplink multiple TRPs mobility). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to inter uplink multiple TRPs mobility). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of inter uplink multiple TRPs mobility as described herein. For example, the communications manager 720 may include an SRS configuration component 725, an SRS component 730, an uplink handover component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. The SRS configuration component 725 is capable of, configured to, or operable to support a means for receiving, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure. The SRS component 730 is capable of, configured to, or operable to support a means for transmitting one or more SRSs via one or more SRS resources associated with the one or more SRS resource sets in accordance with the SRS beam sweeping procedure. The uplink handover component 735 is capable of, configured to, or operable to support a means for receiving, based on the one or more SRSs, an indication to perform the uplink handover procedure from a first uplink TRP of the set of multiple uplink TRPs to a second uplink TRP of the set of multiple uplink TRPs.

In some cases, the SRS configuration component 725, the SRS component 730, or the uplink handover component 735 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the SRS configuration component 725, the SRS component 730, or the uplink handover component 735 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

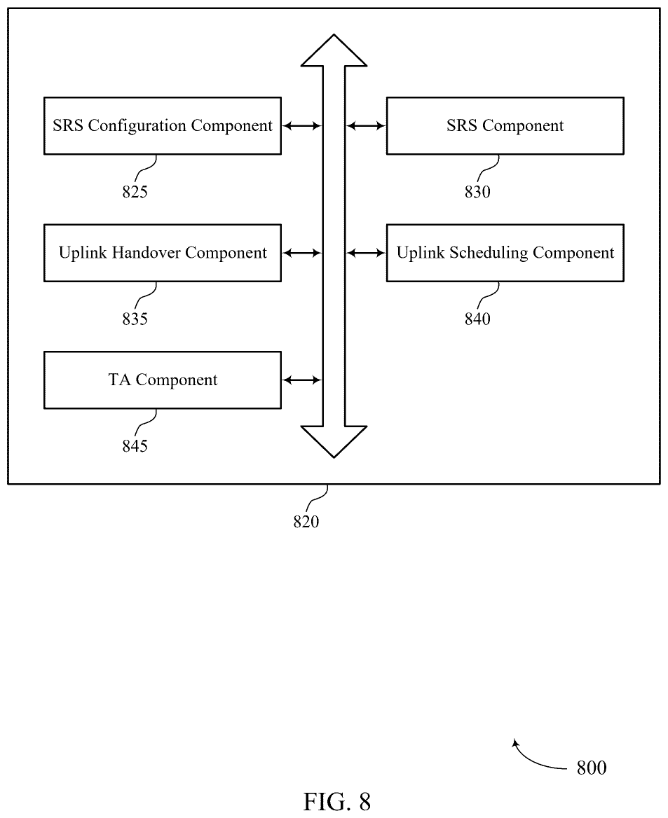

FIG. 8 shows a block diagram 800 of a communications manager 820 that supports inter uplink multiple TRPs mobility in accordance with one or more aspects of the present disclosure. The communications manager 820 may be an example of aspects of a communications manager 620, a communications manager 720, or both, as described herein. The communications manager 820, or various components thereof, may be an example of means for performing various aspects of inter uplink multiple TRPs mobility as described herein. For example, the communications manager 820 may include an SRS configuration component 825, an SRS component 830, an uplink handover component 835, an uplink scheduling component 840, a TA component 845, or any combination thereof. Each of these components, or components or subcomponents thereof (e.g., one or more processors, one or more memories), may communicate, directly or indirectly, with one another (e.g., via one or more buses).

The communications manager 820 may support wireless communication in accordance with examples as disclosed herein. The SRS configuration component 825 is capable of, configured to, or operable to support a means for receiving, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure. The SRS component 830 is capable of, configured to, or operable to support a means for transmitting one or more SRSs via one or more SRS resources associated with the one or more SRS resource sets in accordance with the SRS beam sweeping procedure. The uplink handover component 835 is capable of, configured to, or operable to support a means for receiving, based on the one or more SRSs, an indication to perform the uplink handover procedure from a first uplink TRP of the set of multiple uplink TRPs to a second uplink TRP of the set of multiple uplink TRPs.

In some examples, the uplink scheduling component 840 is capable of, configured to, or operable to support a means for transmitting, to the first uplink TRP, a scheduled uplink transmission. In some examples, the SRS configuration component 825 is capable of, configured to, or operable to support a means for receiving, from the network entity based on the scheduled uplink transmission, a second control signal indicating to perform SRS beam sweeping in accordance with the one or more SRS resource sets for the SRS beam sweeping procedure.

In some examples, to support receiving the second control signal, the SRS configuration component 825 is capable of, configured to, or operable to support a means for receiving a MAC-CE indicating an activation of an SRS resource set associated with the one or more SRS resource sets for the SRS beam sweeping procedure.

In some examples, to support receiving the second control signal, the SRS configuration component 825 is capable of, configured to, or operable to support a means for receiving a DCI including at least an ID of an SRS resource set associated with the one or more SRS resource sets or a quantity of repetitions associated with the SRS beam sweeping procedure.

In some examples, the uplink scheduling component 840 is capable of, configured to, or operable to support a means for transmitting, to the first uplink TRP, an uplink transmission, where a response timer is initiated based on the uplink transmission.

In some examples, the SRS component 830 is capable of, configured to, or operable to support a means for performing the SRS beam sweeping procedure via the one or more SRS resource sets based on a failure to receive a response to the uplink transmission and an expiration of the response timer.

In some examples, the uplink handover component 835 is capable of, configured to, or operable to support a means for transmitting, to the second uplink TRP, a random access message including a dedicated preamble sequence or a contention based preamble sequence based on the indication to perform the uplink handover procedure, the random access message indicating the uplink handover procedure.

In some examples, the TA component 845 is capable of, configured to, or operable to support a means for receiving, from the network entity, a random access response indicating a TA value associated with the second uplink TRP. In some examples, the TA component 845 is capable of, configured to, or operable to support a means for transmitting, to the second uplink TRP, a second random access message indicating confirmation of the uplink handover procedure and in accordance with the TA value.

In some examples, to support receiving the indication to perform the uplink handover procedure, the uplink handover component 835 is capable of, configured to, or operable to support a means for receiving the indication to perform the uplink handover procedure, where the indication includes a PDCCH order PRACH message or an RRC reconfiguration message.

In some cases, the SRS configuration component 825, the SRS component 830, the uplink handover component 835, the uplink scheduling component 840, or the TA component 845 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the SRS configuration component 825, the SRS component 830, the uplink handover component 835, the uplink scheduling component 840, or the TA component 845 discussed herein.

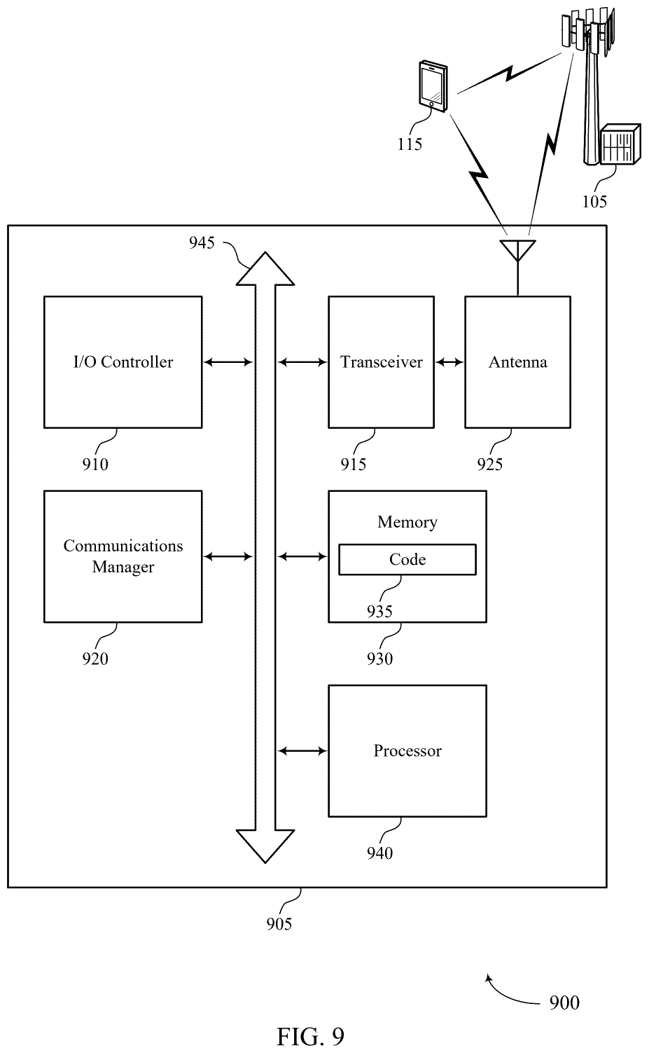

FIG. 9 shows a diagram of a system 900 including a device 905 that supports inter uplink multiple TRPs mobility in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting inter uplink multiple TRPs mobility). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communication in accordance with examples as disclosed herein. For example, the communications manager 920 is capable of, configured to, or operable to support a means for receiving, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure. The communications manager 920 is capable of, configured to, or operable to support a means for transmitting one or more SRSs via one or more SRS resources associated with the one or more SRS resource sets in accordance with the SRS beam sweeping procedure. The communications manager 920 is capable of, configured to, or operable to support a means for receiving, based on the one or more SRSs, an indication to perform the uplink handover procedure from a first uplink TRP of the set of multiple uplink TRPs to a second uplink TRP of the set of multiple uplink TRPs.

By including or configuring the communications manager 920 in accordance with examples as described herein, the device 905 may support techniques for improved communication reliability, reduced latency, more efficient utilization of communication resources, improved coordination between devices, and the like.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of inter uplink multiple TRPs mobility as described herein, or the at least one processor 940 and the at least one memory 930 may be otherwise configured to, individually or collectively, perform or support such operations.

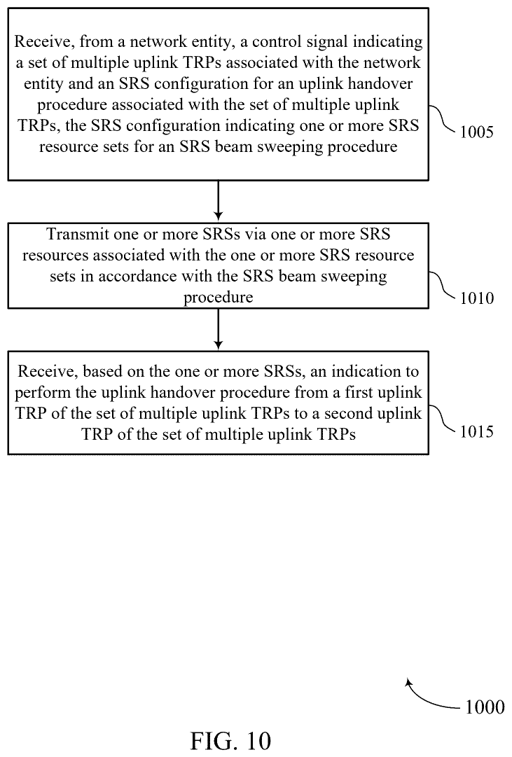

FIG. 10 shows a flowchart illustrating a method 1000 that supports inter uplink multiple TRPs mobility in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure. The operations of 1005 may be performed in accordance with examples as disclosed herein. In some examples, aspects of the operations of 1005 may be performed by an SRS configuration component 825 as described with reference to FIG. 8.

At 1010, the method may include transmitting one or more SRSs via one or more SRS resources associated with the one or more SRS resource sets in accordance with the SRS beam sweeping procedure. The operations of 1010 may be performed in accordance with examples as disclosed herein. In some examples, aspects of the operations of 1010 may be performed by an SRS component 830 as described with reference to FIG. 8.

At 1015, the method may include receiving, based on the one or more SRSs, an indication to perform the uplink handover procedure from a first uplink TRP of the set of multiple uplink TRPs to a second uplink TRP of the set of multiple uplink TRPs. The operations of 1015 may be performed in accordance with examples as disclosed herein. In some examples, aspects of the operations of 1015 may be performed by an uplink handover component 835 as described with reference to FIG. 8.

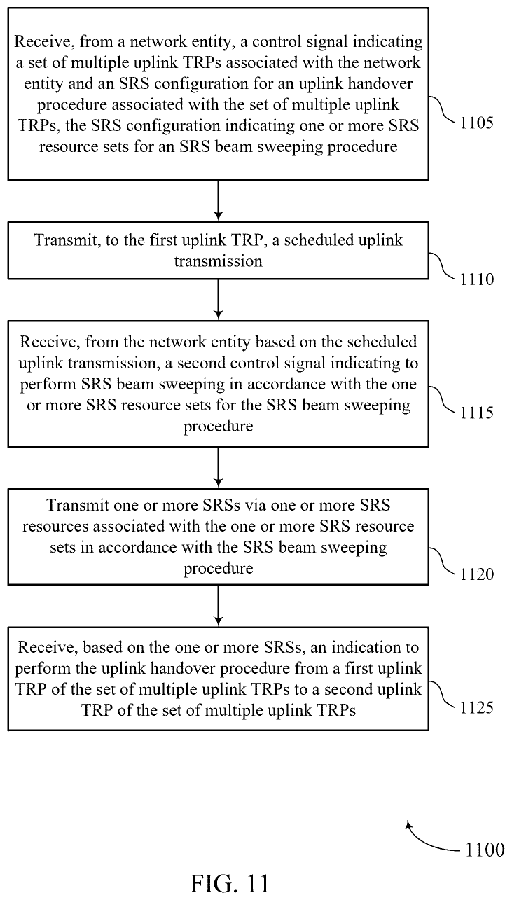

FIG. 11 shows a flowchart illustrating a method 1100 that supports inter uplink multiple TRPs mobility in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure. The operations of 1105 may be performed in accordance with examples as disclosed herein. In some examples, aspects of the operations of 1105 may be performed by an SRS configuration component 825 as described with reference to FIG. 8.

At 1110, the method may include transmitting, to the first uplink TRP, a scheduled uplink transmission. The operations of 1110 may be performed in accordance with examples as disclosed herein. In some examples, aspects of the operations of 1110 may be performed by an uplink scheduling component 840 as described with reference to FIG. 8.

At 1115, the method may include receiving, from the network entity based on the scheduled uplink transmission, a second control signal indicating to perform SRS beam sweeping in accordance with the one or more SRS resource sets for the SRS beam sweeping procedure. The operations of 1115 may be performed in accordance with examples as disclosed herein. In some examples, aspects of the operations of 1115 may be performed by an SRS configuration component 825 as described with reference to FIG. 8.

At 1120, the method may include transmitting one or more SRSs via one or more SRS resources associated with the one or more SRS resource sets in accordance with the SRS beam sweeping procedure. The operations of 1120 may be performed in accordance with examples as disclosed herein. In some examples, aspects of the operations of 1120 may be performed by an SRS component 830 as described with reference to FIG. 8.

At 1125, the method may include receiving, based on the one or more SRSs, an indication to perform the uplink handover procedure from a first uplink TRP of the set of multiple uplink TRPs to a second uplink TRP of the set of multiple uplink TRPs. The operations of 1125 may be performed in accordance with examples as disclosed herein. In some examples, aspects of the operations of 1125 may be performed by an uplink handover component 835 as described with reference to FIG. 8.

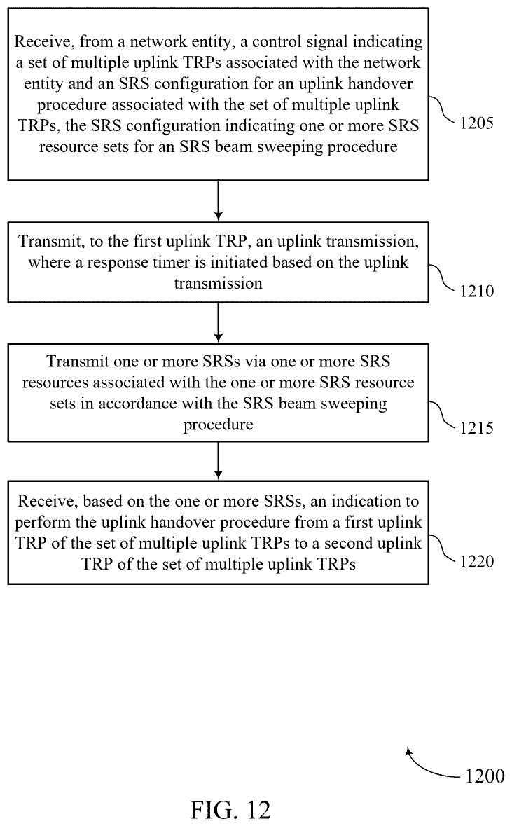

FIG. 12 shows a flowchart illustrating a method 1200 that supports inter uplink multiple TRPs mobility in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include receiving, from a network entity, a control signal indicating a set of multiple uplink TRPs associated with the network entity and an SRS configuration for an uplink handover procedure associated with the set of multiple uplink TRPs, the SRS configuration indicating one or more SRS resource sets for an SRS beam sweeping procedure. The operations of 1205 may be performed in accordance with examples as disclosed herein. In some examples, aspects of the operations of 1205 may be performed by an SRS configuration component 825 as described with reference to FIG. 8.

At 1210, the method may include transmitting, to the first uplink TRP, an uplink transmission, where a response timer is initiated based on the uplink transmission. The operations of 1210 may be performed in accordance with examples as disclosed herein. In some examples, aspects of the operations of 1210 may be performed by an uplink scheduling component 840 as described with reference to FIG. 8.

At 1215, the method may include transmitting one or more SRSs via one or more SRS resources associated with the one or more SRS resource sets in accordance with the SRS beam sweeping procedure. The operations of 1215 may be performed in accordance with examples as disclosed herein. In some examples, aspects of the operations of 1215 may be performed by an SRS component 830 as described with reference to FIG. 8.

At 1220, the method may include receiving, based on the one or more SRSs, an indication to perform the uplink handover procedure from a first uplink TRP of the set of multiple uplink TRPs to a second uplink TRP of the set of multiple uplink TRPs. The operations of 1220 may be performed in accordance with examples as disclosed herein. In some examples, aspects of the operations of 1220 may be performed by an uplink handover component 835 as described with reference to FIG. 8.

The following provides an overview of aspects of the present disclosure:

Aspect 1: A method for wireless communications at a UE, comprising: receiving, from a network entity, a control signal indicating a plurality of uplink TRPs associated with the network entity and an SRS configuration for an uplink handover procedure associated with the plurality of uplink TRPs, the SRS configuration indicating one or more SRS resource sets for an SRS beam sweeping procedure; transmitting one or more SRSs via one or more SRS resources associated with the one or more SRS resource sets in accordance with the SRS beam sweeping procedure; and receiving, based at least in part on the one or more SRSs, an indication to perform the uplink handover procedure from a first uplink TRP of the plurality of uplink TRPs to a second uplink TRP of the plurality of uplink TRPs.

Aspect 2: The method of aspect 1, further comprising: transmitting, to the first uplink TRP, a scheduled uplink transmission; and receiving, from the network entity based at least in part on the scheduled uplink transmission, a second control signal indicating to perform SRS beam sweeping in accordance with the one or more SRS resource sets for the SRS beam sweeping procedure.

Aspect 3: The method of aspect 2, further comprising: receiving a MAC-CE indicating an activation of an SRS resource set associated with the one or more SRS resource sets for the SRS beam sweeping procedure.

Aspect 4: The method of any of aspects 2 through 3, further comprising: receiving a DCI comprising at least an ID of an SRS resource set associated with the one or more SRS resource sets or a quantity of repetitions associated with the SRS beam sweeping procedure.

Aspect 5: The method of aspect 1, further comprising: transmitting, to the first uplink TRP, an uplink transmission, wherein a response timer is initiated based at least in part on the uplink transmission.

Aspect 6: The method of aspect 5, further comprising: performing the SRS beam sweeping procedure via the one or more SRS resource sets based at least in part on a failure to receive a response to the uplink transmission and an expiration of the response timer.

Aspect 7: The method of any of aspects 1 through 6, further comprising: transmitting, to the second uplink TRP, a random access message comprising a dedicated preamble sequence or a contention based preamble sequence based at least in part on the indication to perform the uplink handover procedure, the random access message indicating the uplink handover procedure.

Aspect 8: The method of aspect 7, further comprising: receiving, from the network entity, a random access response indicating a TA value associated with the second uplink TRP; and transmitting, to the second uplink TRP, a second random access message indicating confirmation of the uplink handover procedure and in accordance with the TA value.

Aspect 9: The method of any of aspects 1 through 8, further comprising: receiving the indication to perform the uplink handover procedure, wherein the indication comprises a PDCCH order PRACH message or an RRC reconfiguration message.

Aspect 10: A UE for wireless communications, comprising one or more memories storing processor-executable code, and one or more processors coupled with the one or more memories and individually or collectively operable to execute the code to cause the UE to perform a method of any of aspects 1 through 9.

Aspect 11: A UE for wireless communications, comprising at least one means for performing a method of any of aspects 1 through 9.

Aspect 12: A non-transitory computer-readable medium storing code for wireless communications, the code comprising instructions executable by one or more processors to perform a method of any of aspects 1 through 9.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. ” As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories, wherein the one or more processors are individually or collectively configured to cause the UE to:
receive, from a network entity, a control signal indicating a plurality of uplink transmission-reception points (TRPs) associated with the network entity and a sounding reference signal (SRS) configuration for an uplink handover procedure associated with the plurality of uplink TRPs, the SRS configuration indicating one or more SRS resource sets for an SRS beam sweeping procedure;
transmit one or more SRSs via one or more SRS resources associated with the one or more SRS resource sets in accordance with the SRS beam sweeping procedure; and
receive, based at least in part on the one or more SRSs, an indication to perform the uplink handover procedure from a first uplink TRP of the plurality of uplink TRPs to a second uplink TRP of the plurality of uplink TRPs.

2. The UE of claim 1, wherein the one or more processors are individually or collectively further configured to cause the UE to:
transmit, to the first uplink TRP, a scheduled uplink transmission; and
receive, from the network entity based at least in part on the scheduled uplink transmission, a second control signal indicating to perform SRS beam sweeping in accordance with the one or more SRS resource sets for the SRS beam sweeping procedure.

3. The UE of claim 2, wherein the one or more processors are individually or collectively configured to cause the UE to receive the second control signal by being individually or collectively configured to cause the UE to:
receive a medium access control (MAC) control element (MAC-CE) indicating an activation of an SRS resource set associated with the one or more SRS resource sets for the SRS beam sweeping procedure.

4. The UE of claim 2, wherein the one or more processors are individually or collectively configured to cause the UE to receive the second control signal by being individually or collectively configured to cause the UE to:
receive a downlink control indication (DCI) comprising at least an identifier of an SRS resource set associated with the one or more SRS resource sets or a quantity of repetitions associated with the SRS beam sweeping procedure.

5. The UE of claim 1, wherein the one or more processors are individually or collectively further configured to cause the UE to:
transmit, to the first uplink TRP, an uplink transmission, wherein a response timer is initiated based at least in part on the uplink transmission.

6. The UE of claim 5, wherein the one or more processors are individually or collectively further configured to cause the UE to:
perform the SRS beam sweeping procedure via the one or more SRS resource sets based at least in part on a failure to receive a response to the uplink transmission and an expiration of the response timer.

7. The UE of claim 1, wherein the one or more processors are individually or collectively further configured to cause the UE to:
transmit, to the second uplink TRP, a random access message comprising a dedicated preamble sequence or a contention based preamble sequence based at least in part on the indication to perform the uplink handover procedure, the random access message indicating the uplink handover procedure.

8. The UE of claim 7, wherein the one or more processors are individually or collectively further configured to cause the UE to:
receive, from the network entity, a random access response indicating a timing advance value associated with the second uplink TRP; and
transmit, to the second uplink TRP, a second random access message indicating confirmation of the uplink handover procedure and in accordance with the timing advance value.

9. The UE of claim 1, wherein the one or more processors are individually or collectively configured to cause the UE to re receive the indication to perform the uplink handover procedure by being individually or collectively configured to cause the UE to:
receive the indication to perform the uplink handover procedure, wherein the indication comprises a physical downlink control channel (PDCCH) order physical random access channel (PRACH) message or a radio resource control (RRC) reconfiguration message.

10. A method for wireless communication at a user equipment (UE), comprising:
receiving, from a network entity, a control signal indicating a plurality of uplink transmission-reception points (TRPs) associated with the network entity and a sounding reference signal (SRS) configuration for an uplink handover procedure associated with the plurality of uplink TRPs, the SRS configuration indicating one or more SRS resource sets for an SRS beam sweeping procedure;
transmitting one or more SRSs via one or more SRS resources associated with the one or more SRS resource sets in accordance with the SRS beam sweeping procedure; and
receiving, based at least in part on the one or more SRSs, an indication to perform the uplink handover procedure from a first uplink TRP of the plurality of uplink TRPs to a second uplink TRP of the plurality of uplink TRPs.

11. The method of claim 10, further comprising:
transmitting, to the first uplink TRP, a scheduled uplink transmission; and
receiving, from the network entity based at least in part on the scheduled uplink transmission, a second control signal indicating to perform SRS beam sweeping in accordance with the one or more SRS resource sets for the SRS beam sweeping procedure.

12. The method of claim 11, wherein receiving the second control signal further comprises:
receiving a medium access control (MAC) control element (MAC-CE) indicating an activation of an SRS resource set associated with the one or more SRS resource sets for the SRS beam sweeping procedure.

13. The method of claim 11, wherein receiving the second control signal further comprises:
receiving a downlink control indication (DCI) comprising at least an identifier of an SRS resource set associated with the one or more SRS resource sets or a quantity of repetitions associated with the SRS beam sweeping procedure.

14. The method of claim 10, further comprising:
transmitting, to the first uplink TRP, an uplink transmission, wherein a response timer is initiated based at least in part on the uplink transmission.

15. The method of claim 14, further comprising:
performing the SRS beam sweeping procedure via the one or more SRS resource sets based at least in part on a failure to receive a response to the uplink transmission and an expiration of the response timer.

16. The method of claim 10, further comprising:
transmitting, to the second uplink TRP, a random access message comprising a dedicated preamble sequence or a contention based preamble sequence based at least in part on the indication to perform the uplink handover procedure, the random access message indicating the uplink handover procedure.

17. The method of claim 16, further comprising:
receiving, from the network entity, a random access response indicating a timing advance value associated with the second uplink TRP; and
transmitting, to the second uplink TRP, a second random access message indicating confirmation of the uplink handover procedure and in accordance with the timing advance value.

18. The method of claim 10, wherein receiving the indication to perform the uplink handover procedure further comprises:
receiving the indication to perform the uplink handover procedure, wherein the indication comprises a physical downlink control channel (PDCCH) order physical random access channel (PRACH) message or a radio resource control (RRC) reconfiguration message.

19. A non-transitory computer-readable medium storing code for wireless communication, the code comprising instructions executable by one or more processors to:
receive, from a network entity, a control signal indicating a plurality of uplink transmission-reception points (TRPs) associated with the network entity and a sounding reference signal (SRS) configuration for an uplink handover procedure associated with the plurality of uplink TRPs, the SRS configuration indicating one or more SRS resource sets for an SRS beam sweeping procedure;
transmit one or more SRSs via one or more SRS resources associated with the one or more SRS resource sets in accordance with the SRS beam sweeping procedure; and
receive, based at least in part on the one or more SRSs, an indication to perform the uplink handover procedure from a first uplink TRP of the plurality of uplink TRPs to a second uplink TRP of the plurality of uplink TRPs.

20. The non-transitory computer-readable medium of claim 19, wherein the instructions are further executable by the one or more processors to:
transmit, to the first uplink TRP, a scheduled uplink transmission; and
receive, from the network entity based at least in part on the scheduled uplink transmission, a second control signal indicating to perform SRS beam sweeping in accordance with the one or more SRS resource sets for the SRS beam sweeping procedure.
